(19) United States
(12) Patent Application Publication
(10) Pub. No.: US 2021/0231172 A1
(43) Pub. Date: Jul. 29, 2021

(54) NESTED DOUBLE ECCENTRIC ANCHOR BOLT BUSHINGS

(71) Applicant: Katerra Inc., Menlo Park, CA (US)

(72) Inventor: Steven John Bosko, San Ramon, CA (US)

(73) Assignee: Katerra Inc., Menlo Park, CA (US)

(21) Appl. No.: 17/156,017

(22) Filed: Jan. 22, 2021

Related U.S. Application Data
(60) Provisional application No. 62/965,548, filed on Jan. 24, 2020.

(51) Int. Cl. F16C 33/04; E04B 1/41; F16C 17/02

(52) U.S. Cl. CPC F16C 33/046; F16C 17/02; E04B 1/4157

(57) ABSTRACT

A nested double eccentric anchor bolt bushing device is provided. The device includes a fully eccentric inner sleeve and a fully eccentric outer sleeve. The fully eccentric inner sleeve includes a first outer diameter and a first inner diameter. The first inner diameter of the fully eccentric inner sleeve is configured to receive an anchor bolt. The fully eccentric outer sleeve includes a second inner diameter and a second outer diameter. The second inner diameter is configured to receive the first outer diameter of the fully eccentric inner sleeve. The second outer diameter is configured to insert into an opening in a sill plate of a wall panel. A wall is also provided. The wall includes an anchor bolt, a fully eccentric inner sleeve, a fully eccentric outer sleeve, and a sill plate. A method of installing the wall is also provided.

### CROSS REFERENCE TO RELATED APPLICATION

This application claims the benefit of U.S. Provisional Application No. 38/395,229 filed on Jan. 24, 2020 for NESTED DOUBLE ECCENTRIC BOLT BUSHINGS, which is incorporated by reference as if fully set forth.

### FIELD OF INVENTION

The present invention relates generally to the art of anchoring walls of buildings, and more specifically to a device that safely installs walls to anchor bolts that may be misaligned or installed in accordance to a given placement error tolerance.

### BACKGROUND

When constructing a building, typically anchor bolts are cast-in-place in a concrete foundation. The anchor bolts are secured in place and then the concrete is placed. The anchor bolts must be set in the concrete at locations per the design plans. For example, the anchor bolts may be set 6 inches to 12 inches apart on center. Concrete placement may cause movement of the anchor bolts causing some of the anchor bolts to be off center or some anchor bolts may be misplaced. Because the anchor bolt may be slightly off center, openings in the sill plates of the wall panels to install the wall to the anchor bolts are typically drilled on site at the exact location of the anchor bolts. The size of the opening must allow the anchor bolt to fit tightly into the opening in the sill plate so that the sill plate and wall panel are adequately secured to the foundation and loads applied on the wall may be transferred through the anchor bolt to the foundation. The sill plates are aligned and marked where an opening must be drilled to install the wall panel over the anchor bolt. Onsite aligning, measuring, and drilling are time consuming and therefore costly.

Alternatively, Titen bolts or MSA mudsill anchors are used in lieu of cast-in-place anchors. These alternatives are drilled through the sill plate and into the concrete foundation. However, these bolts or anchors are expensive, time consuming to install, and may cause damage to rebar in the foundation. Additionally, these bolts or anchors are less secure than cast-in-place anchors.

### SUMMARY

A nested double eccentric anchor bolt bushing device is provided. The device includes a fully eccentric inner sleeve and a fully eccentric outer sleeve. The fully eccentric inner sleeve includes a first outer diameter and a first inner diameter. The first inner diameter of the fully eccentric inner sleeve is configured to receive an anchor bolt. The fully eccentric outer sleeve includes a second inner diameter and a second outer diameter. The second inner diameter is configured to receive the first outer diameter of the fully eccentric inner sleeve. The second outer diameter is configured to insert into an opening in a sill plate of a wall panel.

A wall is also provided. The wall includes an anchor bolt, a fully eccentric inner sleeve, a fully eccentric outer sleeve, and a sill plate. The anchor bolt includes a first diameter. The fully eccentric inner sleeve substantially encompasses the anchor bolt. The fully eccentric inner sleeve includes a first inner diameter and a first outer diameter. The first inner diameter is configured to receive the first diameter of the anchor bolt. The fully eccentric outer sleeve substantially encompasses the fully eccentric inner sleeve. The fully eccentric outer sleeve incudes a second inner diameter and a second outer diameter. The second inner diameter is configured to receive the first outer diameter of the fully eccentric inner sleeve. The sill plate includes an opening. The opening has a second diameter to receive the second outer diameter of the fully eccentric outer sleeve. The opening receives the anchor bolt, the fully eccentric inner sleeve, and the fully eccentric outer sleeve.

A method of installing a wall is also provided. The method includes placing a sill plate on a foundation, inserting a fully eccentric inner sleeve, and inserting a fully eccentric outer sleeve. The sill plate is placed on a foundation with an anchor bolt extending up through an opening in the sill plate. The opening includes a second diameter larger than a first diameter of the anchor bolt. The fully eccentric inner sleeve is inserted into the opening with the anchor bolt extending through the fully eccentric inner sleeve. The fully eccentric inner sleeve includes a first inner diameter configured to receive and substantially encompass the anchor bolt and a first outer diameter. The fully eccentric inner sleeve is rotated to adjust the distant between the first outer diameter anchor bolt and the second diameter of the opening in the sill plate. The fully eccentric outer sleeve is inserted into the opening with the anchor bolt and the fully eccentric inner sleeve extending through the fully eccentric outer sleeve. The fully eccentric outer sleeve includes a second inner diameter and a first outer diameter. The second inner diameter is configured to receive and substantially encompass the first outer diameter of the fully eccentric inner sleeve. The second outer diameter is configured to fit tightly into the opening in the sill plate. The fully eccentric outer sleeve is rotated to adjust the angular direction from the anchor bolt to the second diameter of the opening in the sill plate.

### BRIEF DESCRIPTION OF THE DRAWINGS

The foregoing summary, as well as the following detailed description will be better understood when read in conjunction with the appended drawings. For the purpose of illustration, there is shown in the drawings different embodiments. It should be understood, however, that the teachings are not limited to the precise nested double eccentric anchor bolt bushings and method of installation shown.

FIG. 1 is an exploded view of a nested double eccentric anchor bolt bushing device.

FIG. 2 is a top view of the nested double eccentric anchor bolt bushing device.

FIG. 3 is a front view of the nested double eccentric anchor bolt bushing device.

FIG. 4 is a section view of the nested double eccentric anchor bolt bushing device.

FIG. 5 is an exploded view of the nested double eccentric anchor bolt bushing device and a sill plate of a wall.

FIG. 6 is a perspective view of the nested double eccentric anchor bolt bushing device installed in the sill plate.

FIG. 7 is a flow chart of a method of installing the nested double eccentric anchor bolt bushing device.

### DETAILED DESCRIPTION

A nested double eccentric anchor bolt bushing device is provided that allows a sill plate of a wall panel to be predrilled and installed to anchor bolts that may be off center but within a placement error tolerance. The nested double eccentric anchor bolt bushing device saves time and money by eliminating the need to align, measure and drill the sill plate on site. The nested double eccentric anchor bolt device allows the sill plate to be pre-drilled off site. An oversized hole is predrilled in the factory to allow wall panels to be installed to anchor bolts placed off center within tolerance. The bushing device compensates for misplaced anchor bolts used to anchor walls to concrete foundations by allowing the openings in the sill plate to be oversized. The sill plates with oversized anchor bolt holes may be prefabricated and mass produced thereby saving time and labor costs. The resulting annular space is filled with non-deformable sleeves or bushings. The device can be used to install closed wall panels or open wall panels to the anchor bolts. The closed wall panel may be prefabricated. The closed wall panel must have a small opening to permit installation of the nested double eccentric anchor bolt bushing device. However, the design of the device requires little space for installation. The opening in the closed wall panel may be a narrow gap between the bottom of the drywall and the sill plate of the wall panel. After the wall panel is installed and inspected, a baseboard may be installed to cover the narrow gap.

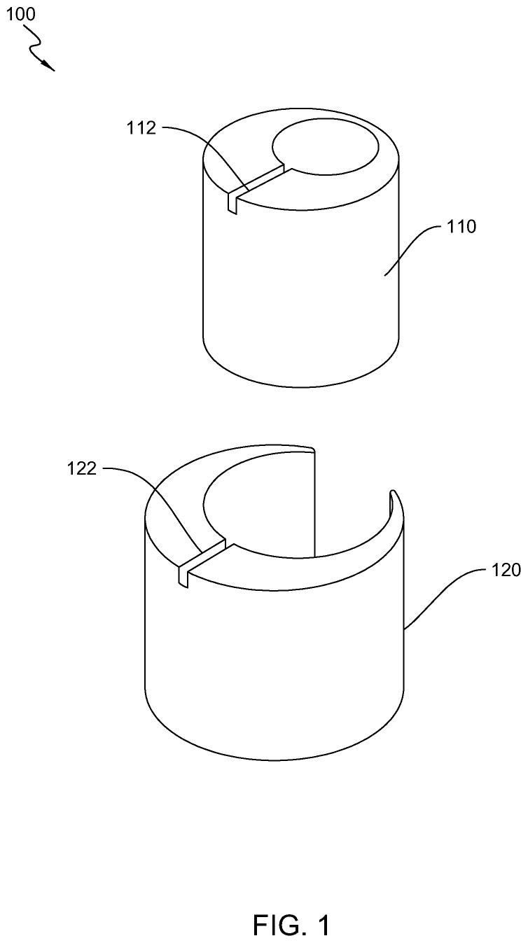

FIG. 1 is an exploded view of a nested double eccentric anchor bolt bushing device 100. As shown in FIG. 1, the nested double eccentric anchor bolt bushing device 100 includes a fully eccentric inner sleeve 110 and a fully eccentric outer sleeve 120. The fully eccentric inner sleeve 110 is configured to nest in the fully eccentric outer sleeve 120. Together, the fully eccentric inner sleeve 110 and the fully eccentric outer sleeve 120 are configured to receive an anchor bolt (not shown in FIG. 1 for clarity) and to fit tightly into an oversized opening drilled in a sill plate of a wall panel (not shown in FIG. 1 for clarity). The fully eccentric inner sleeve 110 is configured to rotate about the anchor bolt to adjust the distance of the anchor bolt to the edge of the oversized opening in the sill plate. The fully eccentric inner sleeve 110 may include a slot 112 configured to receive a tool, such as a flat head screw driver, to rotate the fully eccentric inner sleeve 110 into position after it is inserted into the oversized hole. The fully eccentric outer sleeve 120 is configured to rotate around the fully eccentric inner sleeve 110 to adjust the angular direction from the anchor bolt to the edge of the oversized opening in the sill plate. The fully eccentric outer sleeve 120 may include a slot 122 configured to receive a tool, such as a flat head screw driver, to rotate the fully eccentric outer sleeve 120 into position after it is inserted into the oversized hole.

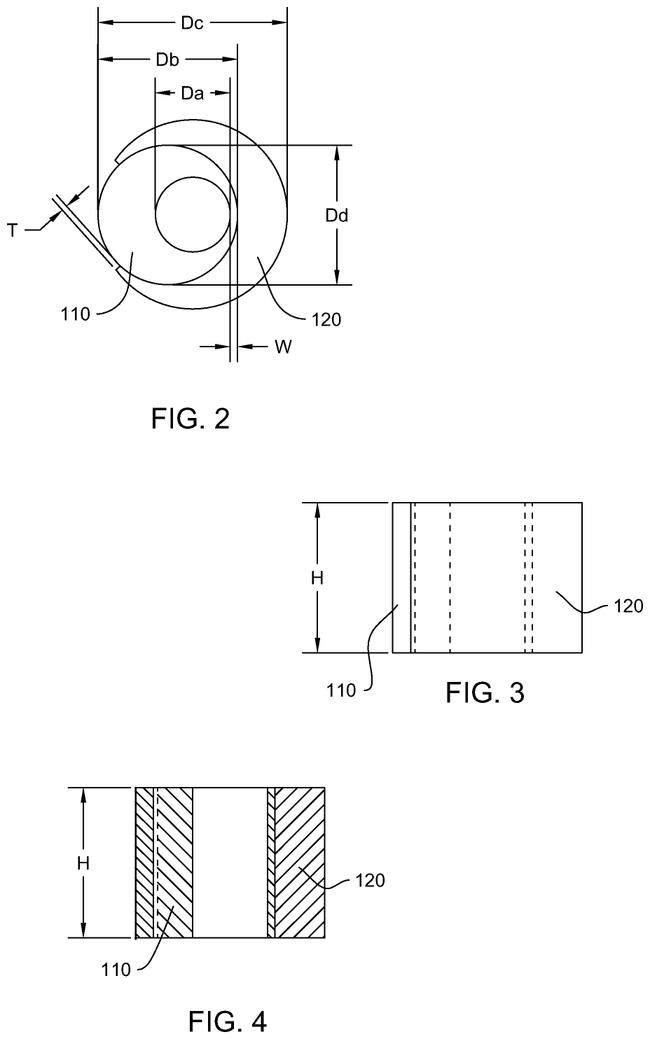

FIG. 2 is a top view of the nested double eccentric anchor bolt bushing device 100. The fully eccentric inner sleeve 110 includes a first inside diameter Da and a first outside diameter Db. The first inside diameter Da is configured to receive an anchor bolt (not shown in FIG. 2 for clarity). The dimension of the first inside diameter Da allows the fully eccentric inner sleeve 110 to receive the anchor bolt and provide a snug fit around the anchor bolt. The dimension of the first inside diameter Da may be the diameter of the anchor bolt plus approximately ⅛ inch to provide a snug fit around the anchor bolt. The anchor bolt diameter may range from approximately ½-1 inch and the inside diameter may range from ⅝-1⅛ inch depending on the diameter of the anchor bolt. The first outside diameter Db is configured to nest in the fully eccentric outer sleeve 120. As shown in FIG. 2, the first inside diameter Da is offset from the center of the first outside diameter Db to make the inner sleeve 110 fully eccentric. When the anchor bolt is inserted through the inside diameter Da of the inner sleeve 110, the anchor bolt will be offset from the center of the first outside diameter Db. Because the inside diameter Da is offset, there is a minimum wall thickness W of the inner sleeve 110. The minimum wall thickness W of the inner sleeve 110 is the minimum distance between a misplaced anchor bolt and the edge of the oversized opening in the sill plate.

The fully eccentric outer sleeve 120 includes a second inside diameter Dd and a second outside diameter Dc. The second inside diameter Dd is approximately equal to the first outside diameter Db of the fully eccentric inner sleeve 110 so that the second inside diameter Dd of the fully eccentric outer sleeve 120 is configured to receive the first outside diameter Db of the fully eccentric inner sleeve 110 and the fully eccentric inner sleeve 110 fits tightly within the second inside diameter Dd of the fully eccentric outer sleeve 120. The second outer diameter Dc of the outer sleeve 120 is dimensioned to fit tightly within the annular space of the inner sleeve 110 and the edge of the oversized opening in the sill plate. As shown in FIG. 2, the second inside diameter Dd is offset from the center of the second outside diameter Dc to make the outer sleeve 120 fully eccentric. The second inside diameter Dd may be offset so that a portion of the outer edge of the outer sleeve 120 is open. The outer sleeve 120 may have a wall thickness T at the open portion. The wall thickness T may be 3/64 inch.

FIG. 3 is a front view of the nested double eccentric anchor bolt bushing device 100. FIG. 4 is a section view of the nested double eccentric anchor bolt bushing device 100. As shown in FIGS. 3-4, the inner sleeve 110 and the outer sleeve 120 have a height H. The height H may be approximately equal to the height of the sill plate to allow the surface of the inner sleeve 110 and outer sleeve 120 to sit flush with the surface of the sill plate after the inner sleeve 110 and outer sleeve 120 are installed. Alternatively, the inner sleeve 110 and the outer sleeve 120 are made from a compressible material and the height H is slightly greater than the height of the sill plate. A greater height H than the height of the sill plate forces the inner sleeve 110 and the outer sleeve 120 to compress downward putting an outward force on the edge of the opening in the sill plate and the anchor bolt when a washer plate and nut are installed over the inner sleeve 110 and outer sleeve 120. The pressure ensures that the device fits tightly in the oversized opening in the sill plate.

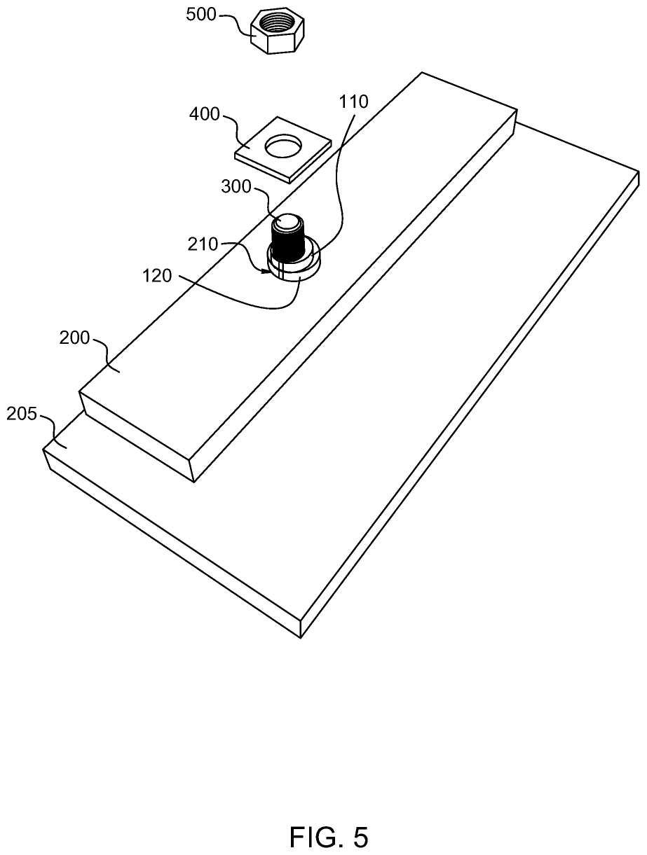

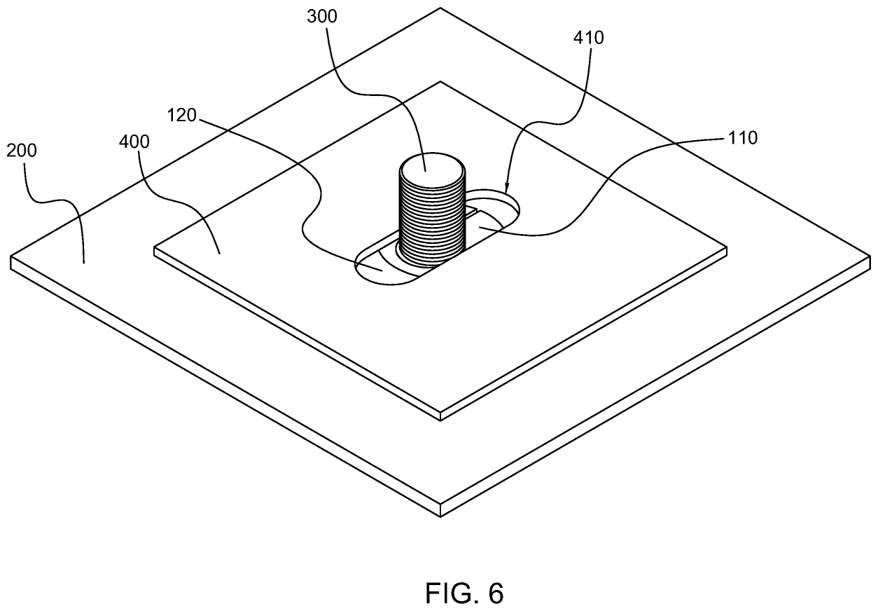

FIG. 5 is an exploded view of the nested double eccentric anchor bolt bushing device 100 and a sill plate 200 of a wall. The sill plate 200 may be wood or steel material. The sill plate 200 includes an oversized opening 210. If the sill plate 200 is steel, the sill plate 200 may include a confinement plate having the oversized opening 210. In this embodiment, the confinement plate is attached to the steel sill plate 200 by either a friction fit, adhesion, or welding.

The sill plate 200 is place onto the foundation 205 and over an anchor bolt 300 with the anchor bolt 300 extending through the opening 210. The opening 210 has a greater diameter than the diameter of the anchor bolt 300. The anchor bolt 300 may shift when the concrete foundation in which the anchor bolt 300 is cast into is placed. The oversized opening 210 in the sill plate 200 allows the anchor bolt 300 to extend through the opening 210 even if the anchor bolt 300 is misplaced or shifts within a bolt placement error tolerance. In some instances, these bolts may be up to approximately 1 inch off center. The inner sleeve 110 is installed over the anchor bolt 300 and into the oversized opening 210. The anchor bolt 300 extends up through the first inner diameter Da of the inner sleeve 110. The anchor bolt 300 fits tightly within the first inner diameter Da of the inner sleeve 110. The outer sleeve 120 is inserted in the annular space between the inner sleeve 110 and the edge of the opening 210 in the sill plate 200. If needed, the inner sleeve 110 and/or outer sleeve 120 may be rotated to properly align and position the sill plate 200 and wall panel. A plate washer 400 may be inserted over the anchor bolt 300. The plate washer 400 lays on the sill plate 200 and the surface of the inner sleeve 110 and outer sleeve 120. As previously described, if the height H of the inner sleeve 110 and outer sleeve 120 is greater than the thickness of the sill plate 200, the plate washer 400 may compress the inner sleeve 110 and outer sleeve 120 so that the inner sleeve 110 and outer sleeve 120 fit tightly between the anchor bolt 300 and the edge of the opening 210 in the sill plate 200. The inner sleeve 110 and outer sleeve 120 must tightly fill the oversized opening 210 so that the sill plate 200 and wall panel are adequately secured to the anchor bolt 300 and loads may be transferred from the wall to the anchor bolt 300 and foundation 205. A nut 500 is installed on the anchor bolt 300 and tightened on the plate washer 400 thereby securing the sill plate 200 to the anchor bolt 300. The nut 500 may be screwed onto the threads of the anchor bolt 300.

The inner sleeve 110 and the outer sleeve 120 may be made of any metal, plastic, or composite material that includes physical properties that may resist and withstand forces that the inner sleeve 110 and outer sleeve 120 must transfer to the bolt 300 and sill plate 200. The material of the inner sleeve 110 and the outer sleeve 120 have a compressive strength profile equal to or great than the sill plate 200 material. The inner sleeve 110 and/or outer sleeve 120 may include grooves that facilitate compression to enable a tight fit in the opening 210 of the sill plate 200. The inner sleeve 110 and/or outer sleeve 120 may include grooves to provide some flexibility of the sleeve 110, 120 to compensate for anchor bolts being out of plumb beyond the first inner diameter Da of the inner sleeve 110. The inner sleeve 110 may also include slight tapers in the design so that the inner sleeve 110 tightens around the anchor bolt 300 as the inner sleeve 110 is driven down into the opening 210. The outer sleeve 120 may also include slight tapers in the design so the outer sleeve 120 forces the sill plate 200 down towards the foundation 205 when the outer sleeve 120 is driven down into the opening 210 of the sill plate 200.

FIG. 6 is a perspective view of the nested double eccentric anchor bolt bushing device 100 installed in the sill plate 200. The nut 500 is not shown in FIG. 6 for clarity. As shown in FIG. 6, the plate washer 400 may include a slot 410 to permit inspection of the inner sleeve 110 and outer sleeve 120. If the plate washer 400 does not have a slot 410, the inner sleeve 110 and outer sleeve 120 may not visible. An inspector would not know if the nested double eccentric anchor bolt bushing device 100 was installed under the plate washer 400. The slot 410 allows an inspector to see the inner sleeve 110 and outer sleeve 120 and know that the nested double eccentric anchor bolt bushing device 100 was in fact installed.

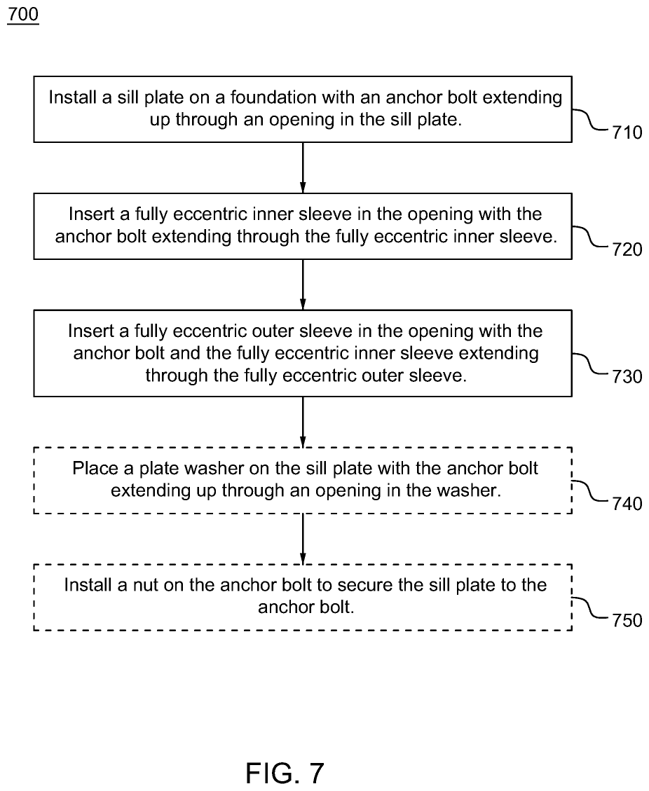

FIG. 7 is a flow chart of a method 700 of installing the nested double eccentric anchor bolt bushing device 100. The nested double eccentric anchor bolt bushing device 100 can quickly and easily be installed saving time and money. The nested double eccentric anchor bolt bushing device 100 is installed according to the steps described below.

In step 710, the sill plate 200 is installed on a foundation 205 with the anchor bolt 300 extending up through the oversized opening 210 in the sill plate 200. The sill plate 200 may be aligned and positioned according to engineering and design plans.

In step 720, the fully eccentric inner sleeve 110 is installed in the opening 210 in the sill plate 200 with the anchor bolt 300 extending through the first inner diameter Da of the inner sleeve 110. The fully eccentric inner sleeve 110 is rotated to adjust the distance between the anchor bolt 300 and the edge of the opening 210 in the sill plate 200. The inner sleeve 110 may be rotated until it comes into contact with the edge of the opening 210 in the sill plate 200.

In step 730, the fully eccentric outer sleeve 120 is installed in the opening 210 in the sill plate 200 with the anchor bolt 300 and inner sleeve 110 extending through the second inner diameter Dd of the outer sleeve 120. The outer sleeve 120 fills the annular space between the inner sleeve 110 and the edge of the opening 210 in the sill plate 200. The fully eccentric outer sleeve 120 is rotated to adjust the angular direction from the anchor bolt 300 to the edge of the opening 210 in the sill plate 200. The outer sleeve 120 and the inner sleeve 110 may be rotated to properly align the sill plate 200 according to design plans. As previously described, the outer sleeve 120 and the inner sleeve 110 may include slots 112, 122 configured to receive a tool to easily rotate the inner and outer sleeves 110, 120. Preferably, the inner sleeve 110 is installed prior to the outer sleeve 120. However, the outer sleeve 120 may be installed prior to the inner sleeve 110 or the inner sleeve 110 and outer sleeve 120 may be installed at the same time.

The method 700 may also include the step 740 of placing a washer 400 over the anchor bolt 300 and onto the sill plate 200 with the anchor bolt 300 extending through the plate washer 400. The washer 400 is used to distribute the load of the anchor bolt 300. The washer 400 also secures the inner sleeve 110 and outer sleeve 120 in place.

The method 700 may also include the step 750 of installing a nut 500 on the anchor bolt 300 to secure the plate washer 400, inner sleeve 110, outer sleeve 120, and sill plate 200 to the anchor bolt 300. The nut 500 is screwed onto the threads of the anchor bolt 300 and tightened against the plate washer 400.

Having thus described in detail a preferred selection of embodiments of the present invention, it is to be appreciated and will be apparent to those skilled in the art that many physical changes could be made to the nested double eccentric anchor bolt bushings and method of installation without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A nested double eccentric anchor bolt bushing device comprising:
a fully eccentric inner sleeve including a first outer diameter and a first inner diameter, the first inner diameter is configured to receive an anchor bolt; and
a fully eccentric outer sleeve including a second inner diameter configured to receive the first outer diameter of the fully eccentric inner sleeve and a second outer diameter configured to insert into an opening in a sill plate of a wall panel.

2. The device of claim 1, wherein at least one of the fully eccentric inner sleeve and the fully eccentric outer sleeve is made from a compressible material.

3. The device of claim 1, wherein at least one of the fully eccentric inner sleeve and the fully eccentric outer sleeve includes a slot configured to receive a tool.

4. The device of claim 1, wherein at least one of the fully eccentric inner sleeve and the fully eccentric outer sleeve includes a plurality of grooves to enable flexibility.

5. The device of claim 1, wherein at least one the fully eccentric inner sleeve and the fully eccentric outer sleeve is made from at least one of metal, plastic, and composite material.

6. The device of claim 1, wherein at least one of the fully eccentric inner sleeve and the fully eccentric outer sleeve is tapered.

7. The device of claim 1, wherein the sill plate is at least one of wood and steel.

8. The device of claim 7, wherein the steel sill plate includes a confinement plate with the opening.

9. A wall comprising:
an anchor bolt including a first diameter;
a fully eccentric inner sleeve substantially encompassing the anchor bolt, the full eccentric inner sleeve including a first inner diameter and a first outer diameter, the first inner diameter is configured to receive the first diameter of the anchor bolt;
a fully eccentric outer sleeve substantially encompassing the fully eccentric inner sleeve, the fully eccentric outer sleeve including a second inner diameter configured to receive the first outer diameter of the fully eccentric inner sleeve and a second outer diameter; and
a sill plate including an opening having a second diameter to receive the second outer diameter of the fully eccentric outer sleeve, the opening receives the anchor bolt, the fully eccentric inner sleeve, and the fully eccentric outer sleeve.

10. The wall of claim 9, wherein at least one of the fully eccentric inner sleeve and the fully eccentric outer sleeve is made from a compressible material.

11. The wall of claim 9, wherein at least one of the fully eccentric inner sleeve and the fully eccentric outer sleeve includes a slot configured to receive a tool.

12. The wall of claim 9, wherein at least one the fully eccentric inner sleeve and the fully eccentric outer sleeve includes a plurality of grooves to enable flexibility.

13. The wall of claim 9, wherein at least one the fully eccentric inner sleeve and the fully eccentric outer sleeve is made from at least one of metal, plastic, and composite material.

14. The wall of claim 9, wherein at least one of the fully eccentric inner sleeve and the fully eccentric outer sleeve is tapered.

15. The wall of claim 9, further including a plate washer and a nut configured to secure the sill plate to the anchor bolt.

16. The wall of claim 15, wherein the plate washer includes a slot configured to allow inspection of the fully eccentric inner sleeve and the fully eccentric outer sleeve after installation.

17. The wall of claim 9, wherein a first height of the fully eccentric inner sleeve and a second height of the fully eccentric outer sleeve are each slightly greater than a third height of the sill plate.

18. The wall of claim 9, wherein the first outer diameter of the fully eccentric outer sleeve is configured to fit tightly into the opening of the sill plate.

19. The wall of claim 9, wherein the sill plate is at least one of wood and steel.

20. The wall of claim 19, wherein the steel sill plate includes a confinement plate having the opening.

21. A method of installing a wall comprising:
placing a sill plate on a foundation with an anchor bolt extending up through an opening in the sill plate, the opening including a second diameter larger than a first diameter of the anchor bolt;
inserting a fully eccentric inner sleeve into the opening with the anchor bolt extending through the fully eccentric inner sleeve, the fully eccentric inner sleeve including a first outer diameter and a first inner diameter configured to receive and substantially encompass the anchor bolt, wherein the fully eccentric inner sleeve is rotated to adjust a distance between the anchor bolt and the second diameter of the opening in the sill plate; and
inserting a fully eccentric outer sleeve into the opening with the anchor bolt and the fully eccentric inner sleeve extending through the fully eccentric outer sleeve, the fully eccentric outer sleeve including a second inner diameter configured to receive and substantially encompass the first outer diameter of the fully eccentric inner sleeve and a second outer diameter configured to fit tightly into the opening in the sill plate, wherein the fully eccentric outer sleeve is rotated to adjust an angular direction from the anchor bolt to the second diameter of the opening in the sill plate.

22. The method of claim 21, wherein inserting the fully eccentric inner sleeve includes rotating the fully eccentric inner sleeve until an outer edge of the fully eccentric inner sleeve contacts an edge of the opening.

23. The method of claim 21, further including placing a plate washer including an opening over the anchor bolt with the anchor bolt extending through the opening of the plate washer and onto the sill plate.

24. The method of claim 21, further including inserting a nut on the anchor bolt and onto the sill plate.

25. The method of claim 21, wherein the sill plate is at least one of wood and steel.

26. The method of claim 25, wherein the steel sill plate includes a confinement plate including the opening.
